(19) United States
(12) Patent Application Publication
(10) Pub. No.: US 2018/0106327 A1
(43) Pub. Date: Apr. 19, 2018

(54) ROPE ATTACHMENT SYSTEM AND METHOD

(71) Applicant: LEWIS KARL VANKEUREN, III, Galena, OH (US)

(72) Inventor: LEWIS KARL VANKEUREN, III, Galena, OH (US)

(21) Appl. No.: 15/292,967

(22) Filed: Oct. 13, 2016

(51) Int. Cl. F16G 11/12

(52) U.S. Cl. CPC F16G 11/12

(57) ABSTRACT

A device and method for securing ropes having rope 1 and frame 2. In one embodiment, frame 2 is a substantially flat and semi rigid plate having three apertures arranged in a triangular pattern. In another embodiment, an elongated rod is shaped to form the three apertures. Other embodiments disclose two pairs of three triangularly arranged apertures. Various methods of securing a rope or ropes to the frames are disclosed.

### BACKGROUND

The present invention relates generally to devices, systems, and methods for using ropes to secure other objects, including other ropes, and specifically to such devices, systems, and methods that facilitate tying off such ropes.

Methods and systems for securing a rope to another object generally fall into one of four categories:

1. systems that rely primarily on the rope configuration relative to the second object, e.g. a knot tied around a pole;

2. systems that rely on the interaction of the rope and a second rope, e.g. a knot tied between two pieces of rope;

3. systems that rely primarily on the mechanical properties of the second object, e.g. a clamp holding a rope; and

4. systems that rely on the interaction of the rope and a rigid second object, e.g. a boat mooring cleat or the “FIG. 8” belay device used in rock climbing.

While knots are generally effective at securing a rope, specialized knowledge is required to properly tie them and utilize them in the appropriate manner. Mechanical systems are sometimes complex to manufacture and operate, and some systems have limited applications (e.g. boat mooring cleat) or require operator interaction to function (e.g. the “FIG. 8” device only retains the rope while the operator maintains tension on the system). Thus, a simplified system of connecting a rope to another object is needed.

### SUMMARY OF THE INVENTION

The invention essentially consists of a rope, or portion of rope, that is passed through three holes (aka apertures or loops) in a symmetrical geometry that creates a constricting force on the rope, thus impeding the reverse movement of the rope through the holes. The present invention has the functionality of a cinch knot or cinch clamp, where the system can be tightened by pulling on the free end of the rope after the system is joined, while being easier to use than a cinch knot or cinch clamp. Those of skill in the art will appreciate that “rope” as used herein, generally comprises a flexible material used to bind or support a load, including natural and man-made materials, including but not limited to cable, wire, cordage, and straps.

The present invention incorporates a frame that is of a rigid or semi-rigid material with holes or loops; a load line defined herein as the portion of the rope that is positioned between the load and the attachment point; and a free line defined herein as the portion of the rope that is positioned on the opposite side of the attachment point, relative to the load. Generally, the free line is sequentially fed through the holes as described herein. Those of skill in the art will appreciate that various rigid or semi-rigid materials can be used commensurate with the load being secured, including but not limited to, metal, plastic, and wood.

### BRIEF DESCRIPTION OF THE DRAWINGS

FIG. 1 is a plan view illustrating a simple embodiment of the rope attachment system.

FIG. 2 is a plan view illustrating attachment of the rope with a bight (or loop).

FIG. 3 is a perspective view illustrating an embodiment of the invention with two attachment points to allow the joining of two portions of rope.

FIG. 4 is a plan view illustrating the geometry of one embodiment of the system.

FIG. 5 is a sectional view along line A-A′ illustrated in FIG. 4.

FIG. 6 is a perspective view of an embodiment of the invention with an elongated center section.

FIG. 7 is a plan view of an embodiment of the invention constructed of a rod.

FIG. 8 is a plan view of the invention illustrated in FIG. 7, with a rope attached.

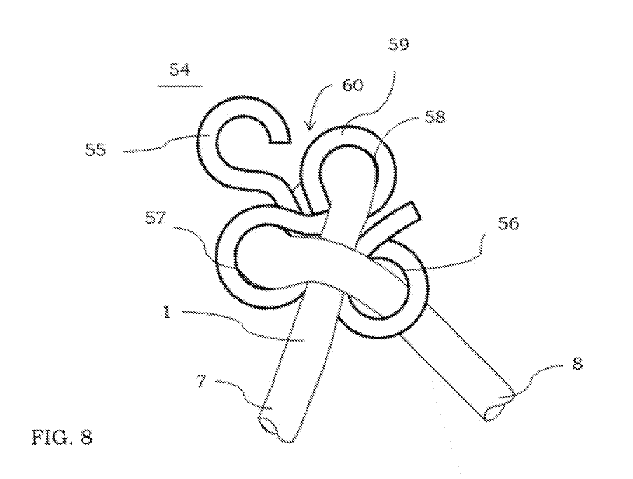

### REFERENCE NUMERALS IN DRAWINGS

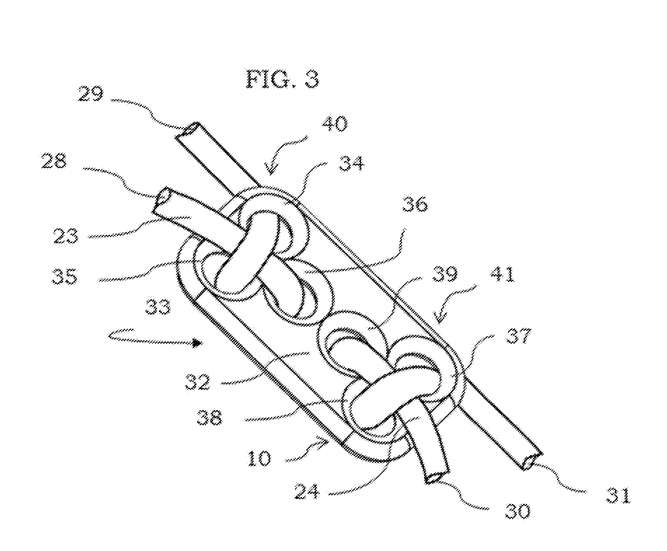

The table below lists the reference numerals employed in the figures, and identifies the element designated by each numeral.
1 rope 1
2 plate 2
3 first hole 3
4 second hole 4
5 third hole 5
6 loop 6
7 free line (aka first end) 7
8 load line (aka second end) 8
9 bight 9
10 frame 10 alternate embodiment of FIG. 3
11 plate thickness 11
12 hole spacing 12
13 rounding radius 13
14 cross section geometry between holes 14
15 hole diameter 15
16 distance between center of hole and center of hole group 16
17 center of hole 17
18 center of hole group 18
19 angle 19
20 middle portion (aka elongated center section) 20 of frame 27
21 first surface 21 of plate 2
22 opposing surface 22 of plate 2
23 first portion of rope 23
24 second portion of rope 24
25 first end portion 25 of frame 27
26 second end portion 26 of frame 27
27 frame 27
28 first end 28 of first portion of rope 23
29 second end 29 of first portion of rope 23
30 first end 30 of second portion of rope 24
31 second end 31 of second portion of rope 24
32 first surface 32 of frame 10
33 opposing surface 33 of frame 10
34 first aperture 34 of frame 10
35 second aperture 35 of frame 10
36 third aperture 36 of frame 10
37 fourth aperture 37 of frame 10
38 fifth aperture 38 of frame 10
39 sixth aperture 39 of frame 10
40 first triangle position 40 of frame 10
41 second triangle position 41 of frame 10
42 first surface 42 of frame 27
43 opposing surface 43 of frame 27
44 first aperture 44 of frame 27
45 second aperture 45 of frame 27
46 third aperture 46 of frame 27
47 fourth aperture 47 of frame 27
48 fifth aperture 48 of frame 27
49 sixth aperture 49 of frame 27
50 first triangle position 50 of frame 27
51 second triangle position 51 of frame 27
52 seventh aperture 52 of frame 27
53 eighth aperture 53 of frame 27
54 frame 54
55 hook portion 55 of frame 54
56 first aperture 56 of frame 54
57 second aperture 57 of frame 54
58 third aperture 58 of frame 54
59 first surface 59 of frame 54
60 opposing surface 60 of frame 54

### DETAILED DESCRIPTION

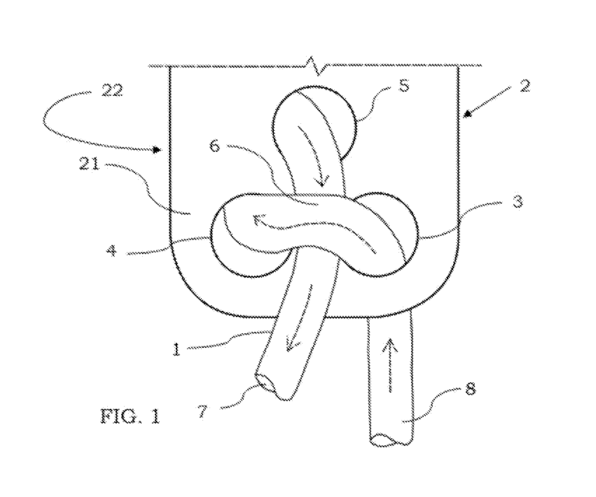

FIG. 1 illustrates one embodiment of the invention comprising rope 1 and frame 2. In this embodiment, frame 2 comprises a substantially flat and semi rigid plate having three apertures in the form of first, second, and third holes, 3, 4, & 5, respectively. Frame 2 has first surface 21 and opposing surface 22.

In operation, free line 7 (aka first end) of rope 1 is passed sequentially through first hole 3 from opposing surface 22, then through second hole 4 from first surface 21, then through third hole 5 from opposing surface 22, and then between first surface 21 and that portion of rope 1 extending between first hole 3 and second hole 4. Thereafter, tension can be placed on the load line (aka second end) 8 by pulling on the free line 7. It should be noted that the symmetry of the hole placement in frame 2, as shown in FIG. 1, allows an arbitrary designation of first and second holes chosen in the sequence, and the choice of first or opposing surfaces chosen for initial insertion.

The following rules apply for securing the rope:

1. the rope must pass through each hole once and only once;

2. the rope must pass through the frame alternating through the first and opposing surfaces on each sequential insertion; and,

3. after the third hole, the rope must pass through the loop created between the first and second hole.

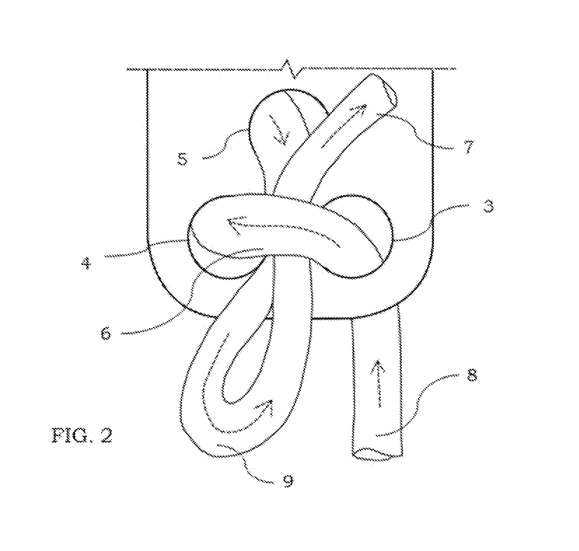

FIG. 2 illustrates an alternative method of joining the system that includes a bight (aka loop) 9 in the free line 7 where it passes through the loop 6 between the first hole 3 and the second hole 4. This allows the system to be quickly and easily released by pulling on the free line 7. Tension can be placed on the load line 8 by pulling on the bight 9.

FIG. 3 illustrates another one of many possible embodiments of the system consisting of six holes in a single frame 10 that provides a means for joining first portion of rope 23 to second portion of rope 24. First and second portions of rope may be part of the same rope or parts of separate pieces of rope, depending on the application. In the embodiment described in FIG. 3, a method for securing two portions of rope 23, 24 comprises the steps of, providing, a first portion of rope 23 having first and second ends 28, 29; a second portion of rope 24 having first and second ends 30, 31; and frame 10 having, first surface 32 and opposing surface 33, first, second, and third apertures 34, 35, 36 arranged in a first triangle position 40; and fourth, fifth, and sixth apertures 37, 38, 39 arranged in a second triangle position 41; passing the first end 28 of the first portion of rope 23 sequentially through the first aperture 34 from the opposing surface 33, then through the second aperture 35 from the first surface 32, then through the third aperture 36 from the opposing surface 33, then between first surface 32 and the portion of the rope extending between the first and second apertures 34, 35; passing the first end 30 of the second portion of rope 24 sequentially through the fourth aperture 37 from the opposing surface 33, then through the fifth aperture 38 from the first surface 32, then through the sixth aperture 39 from the opposing surface 33, then between first surface 32 and the portion of the rope extending between the fourth and fifth apertures 37, 38; whereby the first portion of rope 23 is secured by pulling on the first end 28 of the first portion of rope 23; further whereby the second portion of rope 24 is secured by pulling on the first end 30 of the second portion of rope 24. First and second portions of rope 23, 24 can be from a single rope or two separate ropes.

In one embodiment, frame 10 comprises a substantially flat, semi-rigid plate, and apertures 34 through 39 are in the form of holes through the plate.

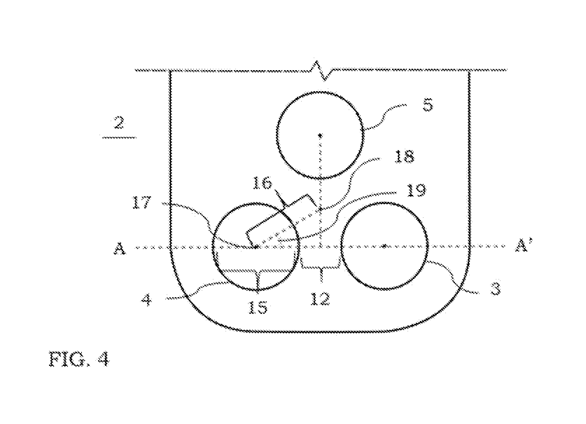

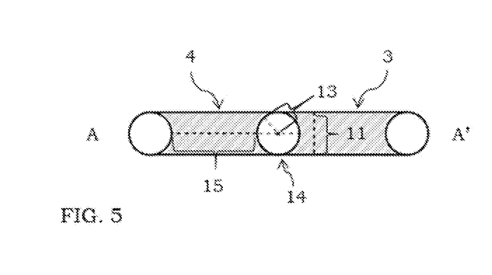

FIG. 4 (a plan view) and FIG. 5 (a sectional view) illustrate the geometry of one possible embodiment of the system. This geometry defines a frame 2 that has the following characteristics:

1. evenly spaced holes;

2. a thickness 11 equal to the hole spacing 12; and

3. rounding on the edges of the holes with a radius 13 equal to one-half the whole spacing 12.

This results in a circular cross section 14 between the holes 3 and 4 that facilitates the rope passing through the holes smoothly. To calculate the dimensions necessary to manufacture a particular frame with circular cross sections between the holes, the following steps are suggested but not necessarily required:

1. the hole spacing 12 is determined based on the rope to be used (generally, the hole spacing 12 should approximate the rope diameter for the system to achieve maximum strength;

2. the hole diameter 15 is determined based on the rope diameter (the hole must be large enough for the rope to pass through) and the intended application (the whole might be sized to accommodate another piece of equipment, e.g. a carabiner);

3. the distance 16 from the center of a hole 17 to the center of the hole group 18 is determined from the following equation:

distance 16=½×(hole diameter 15+hole spacing 12)/cosine angle 19, where angle 19=30°;

4. the frame thickness 11 is set equal to the hole spacing 12;

5. The radius of rounding 13 on a hole 4 is set to one-half the distance between the holes 12.

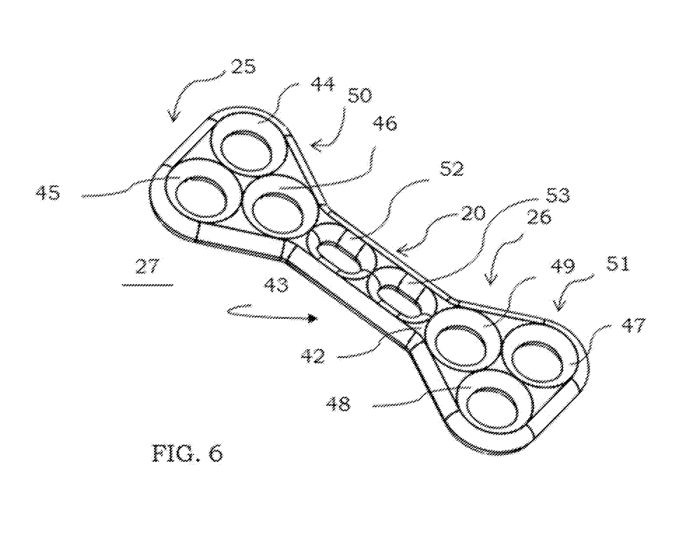

FIG. 6 illustrates another embodiment of the system comprising, first portion of rope 23 (It should be noted that first and second portions of rope 23, 24 are attached to first and second end portions 25, 26 of frame 27 analogously to the manner described in association with FIG. 3) having first and second ends 28, 29; second portion of rope 24 having first and second ends 30, 31; and frame 27 comprising, first surface 42 and an opposing surface 43; first and second end portions 25, 26; a middle portion 20 disposed between the first and second end portions 25, 26; first, second, and third apertures 44, 45, 46 disposed in first end portion 25 and arranged in first triangle position 50; and fourth, fifth, and sixth apertures 47, 48, 49 disposed in second end portion 26 and arranged in second triangle position 51.

In one embodiment, frame 27 comprises a substantially flat, semi-rigid plate, and apertures 44 through 49 are in the form of holes through frame 27.

In one embodiment, middle portion 20 has seventh and eighth apertures 52, 53 disposed therein.

In one embodiment, middle portion 20 is elastic; first portion of rope 23 is secured to first end portion 25; second portion of rope 24 is secured to second end portion 26; whereby middle portion 20 can be elongated prior to the first and/or second portions of rope being secured in order to add additional tension. Elongated center section 20 could be cast or otherwise formed of a resilient and/or elastic material, such as rubber, resulting in the invention having characteristics similar to a bungee cord or rubber tie-down strap; the frame would be elongated when the free line is pulled taut, resulting in static tension on the system afterward.

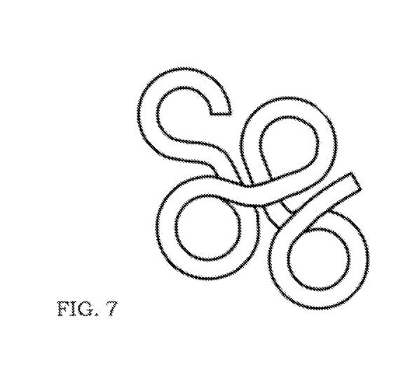

FIGS. 7 & 8 illustrate another embodiment of the system wherein, frame 54 is fashioned from a steel rod or similar material to form an adjustable tie-down hook comprising an elongated rod shaped to form the first, second, and third apertures 56, 57, 58; the connectivity of the rope is analogous to the description associated with FIG. 1. In one embodiment, frame 54 further comprises rod being shaped to include a hook portion 55. It is also possible to join two such arrangements in a manner similar to the embodiments depicted in FIGS. 3 & 6. One unitary piece of rod can be used or alternatively two separate rods can be joined by a middle portion that can be rigid, semi-rigid, or elastic.

What is claimed is:

1. A method for securing a rope comprising the steps of:
providing,
a rope having first and second ends,
and a frame having,
a first surface and an opposing surface,
and first, second, and third apertures;
passing the first end of the rope sequentially through:
the first aperture from the opposing surface,
then through the second aperture from the first surface,
then through the third aperture from the opposing surface,
then between the first surface and the portion of the rope extending between the first and second apertures;
whereby the rope is secured by pulling on the first end of the rope.

2. The method of claim 1 further comprising:
the frame comprising a substantially flat, semi-rigid plate;
the apertures being in the form of holes formed through the plate.

3. The method of claim 1 further comprising:
the frame comprising an elongated rod shaped to form the first, second, and third apertures.

4. The method of claim 3 further comprising:
the frame further comprising one end of the rod being shaped to include a hook portion.

5. The method of claim 1 further comprising:
after passing the first end of the rope between the first surface and the portion of the rope extending between the first and second apertures, forming a loop by again passing the first end of the rope between the first surface and the portion of the rope extending between the first and second apertures in an opposite direction;
whereby the rope is secured by pulling on the loop;
further whereby the rope is unsecured by pulling on the first end of the rope.

6. A method for securing two portions of rope comprising the steps of:
providing,
a first portion of rope having first and second ends;
a second portion of rope having first and second ends;
and a frame having,
a first surface and an opposing surface,
first, second, and third apertures arranged in a first triangle position;
and fourth, fifth, and sixth apertures arranged in a second triangle position;
passing the first end of the first portion of rope sequentially through:
the first aperture from the opposing surface,
then through the second aperture from the first surface,
then through the third aperture from the opposing surface,
then between the first surface and the portion of the rope extending between the first and second apertures;
passing the first end of the second portion of rope sequentially through:
the fourth aperture from the opposing surface,
then through the fifth aperture from the first surface,
then through the sixth aperture from the opposing surface,
then between the first surface and the portion of the rope extending between the fourth and fifth apertures;
whereby the first portion of rope is secured by pulling on the first end of the first portion of rope;
further whereby the second portion of rope is secured by pulling on the first end of the second portion of rope.

7. The method of claim 6 further comprising:
the frame comprising a substantially flat, semi-rigid plate;
the apertures in the form of holes through the plate.

8. A device for securing a rope comprising:
a first portion of rope having first and second ends;
a second portion of rope having first and second ends;
and a frame comprising:
a first surface and an opposing surface;
first and second end portions;
a middle portion disposed between the first and second end portions;
first, second, and third apertures disposed in the first end portion and arranged in a first triangle position;
and fourth, fifth, and sixth apertures disposed in the second end portion and arranged in a second triangle position;

9. The device of claim 8 further comprising:
the middle portion having seventh and eighth apertures disposed therein.

10. The device of claim 8 further comprising:
the middle portion being elastic;
the first portion of rope being secured to the first end portion;
the second portion of rope being secured to the second end portion;
whereby the middle portion can be elongated prior to the first and/or second portions of rope being secured in order to add additional tension.

11. The device of claim 8 further comprising:
the frame comprising a substantially flat, semi-rigid plate;
the apertures being in the form of holes through the plate.
